(19) United States
(12) Patent Application Publication
(10) Pub. No.: US 2003/0003031 A1
(43) Pub. Date: Jan. 2, 2003

(54) Thermally insulated exhaust-gas cleaning installation

(76) Inventors: Rolf Bruck, Bergisch Gladbach (DE); Kait Althofer, Wiehl (DE)

Correspondence Address: LERNER AND GREENBERG, P.A., Post Office Box 2480, Hollywood, FL, 33022-2480, US

(21) Appl. No.: 10/192,178

(22) Filed: Jul. 10, 2002

Related U.S. Application Data
(63) Continuation of application No. PCT/EP00/12496, filed on Dec. 11, 2000.

(30) Foreign Application Priority Data
Jan. 10, 2000 (DE) 100 00 568.3

(51) Int. Cl. B01D 53/92; F01N 3/28; B01J 35/04

(52) U.S. Cl. 422/180; 422/174; 422/177; 422/179

(57) ABSTRACT

An exhaust gas system for an internal combustion engine includes an exhaust gas cleaning installation provided with an entry region, an exit region and a central region. A catalytic converter is disposed in the central region, a first honeycomb body is disposed in the entry region and a second honeycomb body is disposed in the exit region. Exhaust gas can flow through the first and second honeycomb bodies and the catalytic converter. The shape, fastening and/or configuration of at least one of the honeycomb bodies forms thermal insulation. The thermal insulation reduces thermal conduction and/or thermal radiation from the catalytic converter to the remainder of the exhaust gas system. In this manner, the central region is maintained at a temperature required for catalytic conversion for a prolonged period of time so that pollutants are catalytically removed immediately when the internal combustion engine is re-started. Conical honeycomb bodies that are especially provided with smaller end surfaces which are thermally decoupled towards the exterior, are particularly suited as at least one of the honeycomb bodies.

### CROSS-REFERENCE TO RELATED APPLICATION

This application is a continuation of copending International Application No. PCT/EP00/12496, filed Dec. 11, 2000, which designated the United States and was not published in English.

### BACKGROUND OF THE INVENTION

1. Field of the Invention

The invention relates to an exhaust gas system, preferably for an internal combustion engine, having a thermally insulated exhaust-gas cleaning installation.

Due to statutory provisions which are imposing ever higher demands on the exhaust systems used in automotive engineering, the exhaust systems have been the subject of constant further development in the past. In that context, it is of particular interest for suitable thermal conditions in the exhaust system, which are required for optimum conversion of pollutants, to be reached quickly and maintained. One possible way of ensuring that those thermal conditions are present is for the exhaust system to be thermally insulated from the environment.

U.S. Pat. No. 5,477,676 has described a vacuum-insulated catalytic converter. The vacuum insulation can be matched to the operating temperatures in the interior of the catalytic converter. That means that at elevated temperatures the vacuum is replaced by a gas, in order to allow heat to be dissipated from the exhaust system in a controlled manner and thus to prevent overheating. The vacuum-insulated converter is additionally surrounded by heat exchangers. Furthermore, that U.S. patent describes surrounding the vacuum-insulated converter with a phase change material which is distinguished by the fact that it changes its state of aggregation in the region of the operating temperatures of the catalytic converter. In that way it is able to store an increased amount of thermal energy.

The above-described devices insulate a catalytic converter from a radially surrounding environment. Thermal conduction or thermal radiation from the catalytic converter preferentially takes place in the axial direction into the remainder of the exhaust system due to effective radial insulation.

### SUMMARY OF THE INVENTION

It is accordingly an object of the invention to provide an exhaust system, which overcomes the hereinafore-mentioned disadvantages of the heretofore-known devices of this general type, which has improved thermal insulation and which in particular reduces thermal conduction or thermal radiation in axial direction from a catalytic converter into the remainder of an exhaust system.

With the foregoing and other objects in view there is provided, in accordance with the invention, an exhaust gas system for an internal combustion engine, comprising an exhaust-gas cleaning installation having an entry region, an exit region and a central region. A catalytic converter is disposed in the central region, a first honeycomb body is disposed in the entry region and a second honeycomb body is disposed in the exit region, for conducting an exhaust gas flow through the first and second honeycomb bodies and the catalytic converter. At least one of the honeycomb bodies is constructed, secured and/or disposed to form thermal insulation reducing axial thermal conduction and/or thermal radiation from the catalytic converter into the remainder of the exhaust system. The first honeycomb body has a first entry end surface and a first exit end surface. The first entry end surface is smaller than the first exit end surface. The first honeycomb body is oriented with the first exit end surface directed toward the catalytic converter.

Exhaust-gas cleaning installations according to the prior art often have a pipe-like feed line and discharge line for the exhaust gas, with funnel-shaped widenings for connection to an exhaust-gas cleaning system. Those widened sections are for the most part not thermally insulated with respect to the environment and consequently cool more rapidly. Due to the rapid cooling of the exhaust gas in those regions and the sufficient space available, those regions are where convection preferentially occurs. The thermally differing conditions in the feed line and discharge line compared to the exhaust-gas cleaning system result in a uniform temperature level being sought after. That is prevented by the configuration, the nature of the installation and/or the securing of the honeycomb bodies in accordance with the invention. The first honeycomb body represents thermal insulation with respect to upstream components of the exhaust system, and the second honeycomb body represents insulation with respect to downstream components.

In accordance with another feature of the invention, the first honeycomb body and/or the second honeycomb body are made from a thermally insulating material. If the honeycomb bodies and the catalytic converter are in direct or indirect contact with one another, thermal conduction can be suppressed as a result of the thermally insulated material of the honeycomb bodies. If a honeycomb body and the catalytic converter are not connected, then an axial transmission of the heat in the honeycomb body, due to the thermal energy radiated onto the honeycomb body from the converter, is likewise scarcely possible. In this context, it is particularly advantageous for the first and/or second honeycomb body to be made from ceramic material, but other advantageous measures in accordance with the present invention can only be achieved with difficulty by using ceramic honeycomb bodies.

In accordance with a further feature of the invention, the first honeycomb body and/or the second honeycomb body have an electrical heater. This heater can be used, for example, to eliminate a temperature drop in the immediate vicinity as compared to the temperature of the catalytic converter and to thereby counteract loss of its thermal energy.

In accordance with an added feature of the invention, the first honeycomb body is conically constructed, which has the advantage of providing a relatively small entry end surface, that is directed upstream. In this way, the first honeycomb body provides only a small area which may emit heat to components that adjoin it in the upstream direction. This reduces the removal of thermal energy from the exhaust-gas cleaning installation.

In accordance with an additional feature of the invention, in a similar manner, it is particularly advantageous for the second honeycomb body likewise to be of conical construction and to be positioned in such a manner in the exhaust-gas cleaning installation that its smaller second exit surface is directed downstream. In this way, the dissipation of heat to downstream components of the exhaust system and/or the environment may be avoided.

In accordance with yet another feature of the invention, the honeycomb bodies and the catalytic converter are disposed at a distance from one another. There is a respective air gap between each honeycomb body and the catalytic converter. The air gap itself has relatively good thermal insulation properties if no convection takes place therein. In order to achieve this, it must be particularly narrow and/or have measures for preventing convection. Therefore, it is particularly advantageous if the first honeycomb body and/or the second honeycomb body have axial extensions which pass into the air gap. These axial extensions are to be constructed in such a manner that convection in the air gap is reduced. Reduced convection in the air gap prevents end-side cooling of the catalytic converter.

In accordance with yet a further feature of the invention, the first honeycomb body and/or the second honeycomb body are produced by winding and/or stacking and have at least partially structured foil layers. The first honeycomb body and/or the second honeycomb body are distinguished by the fact that the foils have a foil thickness of 0.015 to 0.035 mm. This very small foil thickness means that, considered at the end sides, the honeycomb body has an extremely low percentage of its area filled by metal. The area is predominantly air, which has an insulating action with respect to thermal conduction in the axial direction.

In accordance with yet an added feature of the invention, the first honeycomb body and/or the second honeycomb body is constructed with at least one thermally decoupled end surface. This means that the thermal conduction is also impeded in the axial direction within a honeycomb body. In this way, heat exchange between the interior of the honeycomb body and an end surface, which is generally cooler during the cooling operation, can be reduced.

In accordance with yet an additional feature of the invention, the first honeycomb body and/or the second honeycomb body have at least one slot in their interiors. The slot is disposed close to a thermally decoupled end surface. The slot forms an air gap which reduces the thermal conduction from the end surface to the interior. It is particularly advantageous for the slot to have an encircling construction, extending radially inward from the outer side. It is especially advantageous if the slot has at least one notch. The term notch is intended to mean interruptions in the slot profile which ensure the strength of the honeycomb body even under dynamic load.

In accordance with still another feature of the invention, a thermally decoupled end surface is produced by placing a plurality of slots, preferably in different planes, perpendicular to a preferred direction of flow of the exhaust gas. The planes in which the slots are disposed are at a short distance from one another. In this way, the areal insulation is increased through a predeterminable volume range through the use of at least one slot in a plane. This assists the thermal decoupling of the end surface. It is particularly advantageous for a plurality of slots and notches to be disposed in one plane, in which case the slots and/or the notches are disposed offset in different planes. What this means is that, as seen in the direction of flow, there is an at least partial overlap between a slot in one plane and a notch in a following plane. A honeycomb body constructed in this way only offers reduced axial thermal conduction, since this configuration results in a type of labyrinth for the heat flux.

In accordance with still a further feature of the invention, the first honeycomb body and/or the second honeycomb body are at an axial distance of only 1 to 2 mm from the catalytic converter. This results in a sufficiently large gap between the honeycomb bodies and the converter to suppress thermal conduction from the converter to the honeycomb bodies without it being possible for considerable convection to develop. In this context, it is particularly advantageous if the honeycomb bodies are spaced apart from the catalytic converter through the use of insulating securing elements. Insulating securing elements prevent thermal conduction and, moreover, offer the possibility of ensuring that there is a predeterminable distance between honeycomb body and converter. The stability and fatigue strength of the exhaust-gas cleaning installation described herein can be increased in this way.

In accordance with still an added feature of the invention, the exhaust-gas cleaning installation is constructed with a catalytic converter which has thermally decoupled end surfaces. In this way, additional thermal conduction blockades are produced, which are integrated in the catalytic converter and likewise act in the manner described above.

In accordance with still an additional feature of the invention, the catalytic converter has at least partially structured sheet-metal layers which are produced by winding and/or stacking. The metal sheets are distinguished by the fact that they have a metal-sheet thickness of 0.08 mm to 0.11 mm. The use of thicker metal sheets for the catalytic converter as compared to the honeycomb bodies has the advantage of permitting the catalytic converter to store more thermal energy and cool down significantly more slowly.

In accordance with again another feature of the invention, the exhaust-gas cleaning installation is constructed with additional convection barriers which are disposed between the exhaust-gas cleaning installation and the catalytic converter, the first honeycomb body and the second honeycomb body. These convection barriers are in particular constructed in such a manner that in the outer region they extend radially into a gap between each respective honeycomb body and the catalytic converter, but without excessively impeding the flow. In this way, the cooling of the end surfaces which adjoin the air gap can be reduced.

In accordance with again a further feature of the invention, the exhaust-gas cleaning installation is preferably constructed in such a manner that it is thermally insulated on the radially outer side. The radially outer regions represent a considerable interface with the environment, which is particularly relevant to the mechanisms of dissipation of heat from the exhaust-gas cleaning installation to the environment. The thermal insulation in the axial direction, i.e. in the direction of flow of the exhaust gas, is particularly necessary for exhaust systems which also have a radial insulation of this type.

In accordance with again an added feature of the invention, the first honeycomb body and/or the second honeycomb body are secured in a thermally insulated manner to the exhaust-gas cleaning installation. Particularly when fixing conically shaped honeycomb bodies, it is appropriate for them to be secured to the exhaust-gas cleaning installation. A thermally insulated connection also reduces the thermal conduction out of the honeycomb body into the remaining exhaust system.

In accordance with again an additional feature of the invention, at least the first honeycomb body has a catalytically active surface, along which the exhaust gas that is to be cleaned flows and at which this gas is catalytically converted. During standard operation of the exhaust system, i.e. at a temperature of the catalytic converter which is suitable for effective conversion of pollutants, the exhaust gas is cleaned predominantly by the converter. Nevertheless, a supplementary catalytic activity on the part of the honeycomb bodies is advantageous and makes it possible to comply with the required exhaust emissions stipulations with regard to the residual levels of pollutants which are emitted to the environment.

In accordance with another feature of the invention, it is particularly advantageous with regard to the light-off performance of the exhaust-gas installation after a prolonged break to provide the first honeycomb body with a catalytically active surface. After a long time, the catalytic converter has, for example, cooled to the external ambient temperature. After the internal combustion engine has been started, the converter requires a certain time before it has heated to a temperature of, for example, over 300° C. by the exhaust gas flowing through it in order to allow effective conversion of pollutants, in particular because of its high heat capacity, which is otherwise desirable. In order to ensure that the prescribed cleaning action is achieved by the exhaust-gas installation even during this cold-start phase, according to a further exemplary embodiment the first honeycomb body is constructed in such a way that, during this phase, it has a conversion rate with regard to hydrocarbons and carbon monoxide of at least 80% after 10 to 20 seconds. In particular, the honeycomb body has a volume of 0.2 to 1.0 liter, preferably of 0.6 liter.

In accordance with a concomitant feature of the invention, the cold-starting performance after a prolonged operating break can be improved by an additional primary catalytic converter, which is connected upstream of the exhaust system. This converter is disposed closer to the internal combustion engine and accordingly hotter exhaust gases flow through it. Catalytic conversion can take place after a shorter time at this location. Moreover, the catalytic reaction leads to an increase in the exhaust-gas temperature, and this exhaust gas then flows into the downstream exhaust system. It is particularly advantageous if the upstream-converter can by electrically heated. When the required temperature has been reached in the exhaust system, the catalytic converter disposed downstream once again contributes to complete exhaust-gas cleaning.

Other features which are considered as characteristic for the invention are set forth in the appended claims.

Although the invention is illustrated and described herein as embodied in a thermally insulated exhaust-gas cleaning installation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, sectional view of an exemplary embodiment of an exhaust-gas cleaning installation;

FIG. 2 is a side-elevational view of an embodiment of a honeycomb body;

FIG. 3 is a side-elevational view of a further exemplary embodiment of a honeycomb body;

FIG. 4A is an end-elevational view of an exemplary embodiment of a honeycomb body and FIG. 4B is an enlarged end-elevational view of a portion of FIG. 4; and

FIG. 5A is an end-elevational view of an exemplary embodiment of a catalytic converter and FIG. 5B is an enlarged end-elevational view of a portion of FIG. 5.

### DESCRIPTION OF THE PREFERRED EMBODIMENTS

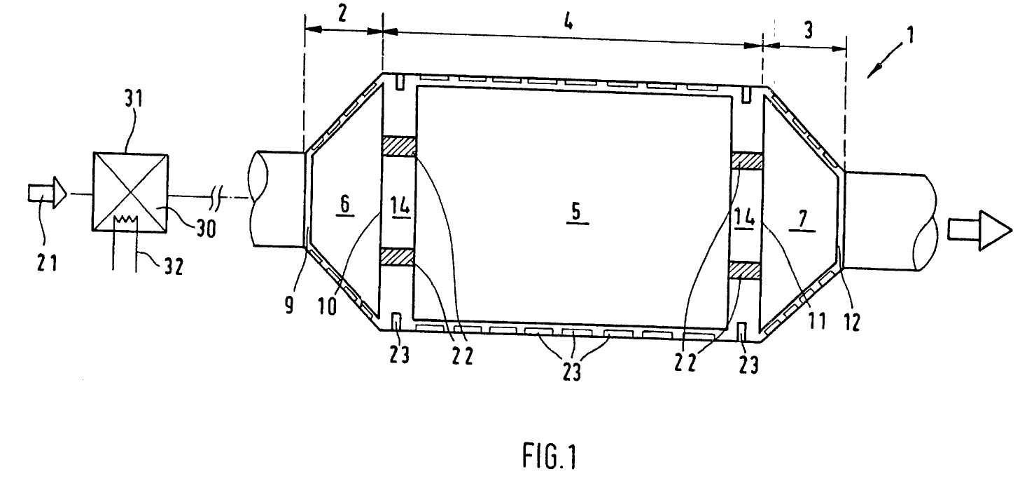

Referring now to the figures of the drawings in detail and first, particularly, to FIG. 1 thereof, there is seen an exhaust-gas cleaning installation 1 through which an exhaust gas can flow in a preferred direction of flow 21. The exhaust-gas cleaning installation 1 has en entry region 2, an exit region 3 and a central region 4. A catalytic converter 5 is disposed in the central region 4. A first honeycomb body 6 is located upstream of the catalytic converter 5, in the entry region 2 of the exhaust-gas cleaning installation 1. A second honeycomb body 7 is disposed in the exit region 3. The exhaust gas can flow through the honeycomb bodies 6 and 7 and the catalytic converter 5. Furthermore, the exhaust-gas cleaning installation 1 has different measures for thermal insulation, which are explained in the following text.

In FIG. 1, the two honeycomb bodies 6 and 7 have a conical construction. The first honeycomb body 6 has a smaller first entry end surface 9 and a larger first exit end surface 10. The first honeycomb body 6 is oriented in such a manner that the smaller first entry end surface 9 faces upstream. A dissipation of heat from the first entry end surface 9 to upstream regions of the exhaust-gas cleaning installation 1 can be reduced as a result. The conical shape of the first honeycomb body 6 means that it can be disposed relatively close to a pipe-like exhaust-gas feed line. This is particularly advantageous since as a result there is scarcely any space for convection between the first honeycomb body 6 and the exhaust-gas cleaning installation 1.

The second honeycomb body 7 is disposed substantially mirror-symmetrically with respect to the first honeycomb body 6. Accordingly, the second honeycomb body 7 has a second entry end surface 11, which is constructed to be larger than a second exit end surface 12. This ensures reduced-dissipation of heat from the second exit end surface 12.

The exhaust-gas cleaning installation 1 shown in FIG. 1 is constructed with a respective narrow air gap 14 between the first honeycomb body 6 and the catalytic converter 5, on one hand, and a respective narrow air gap 14 between the catalytic converter 5 and the second honeycomb body 7, on the other hand. Thermally insulated securing elements 22 are used to ensure that the honeycomb bodies 6 and 7 are spaced apart from the catalytic converter 5. The narrow air gaps 14 and the thermally insulated securing elements 22 prevent axial thermal conduction from the catalytic converter 5 to the honeycomb bodies 6 and 7.

If the air gaps 14 are made wide for structural reasons, the entire exhaust-gas cleaning installation 1 may also be constructed with convection barriers 23 on the outside, which prevent convection on the outside without greatly influencing the flow of exhaust gas.

In addition, FIG. 1 diagrammatically depicts an option of providing a primary catalytic converter 31 with a volume 30 upstream of the remaining exhaust-gas cleaning installation 1. This primary catalytic converter may also have an electrical heater 32.

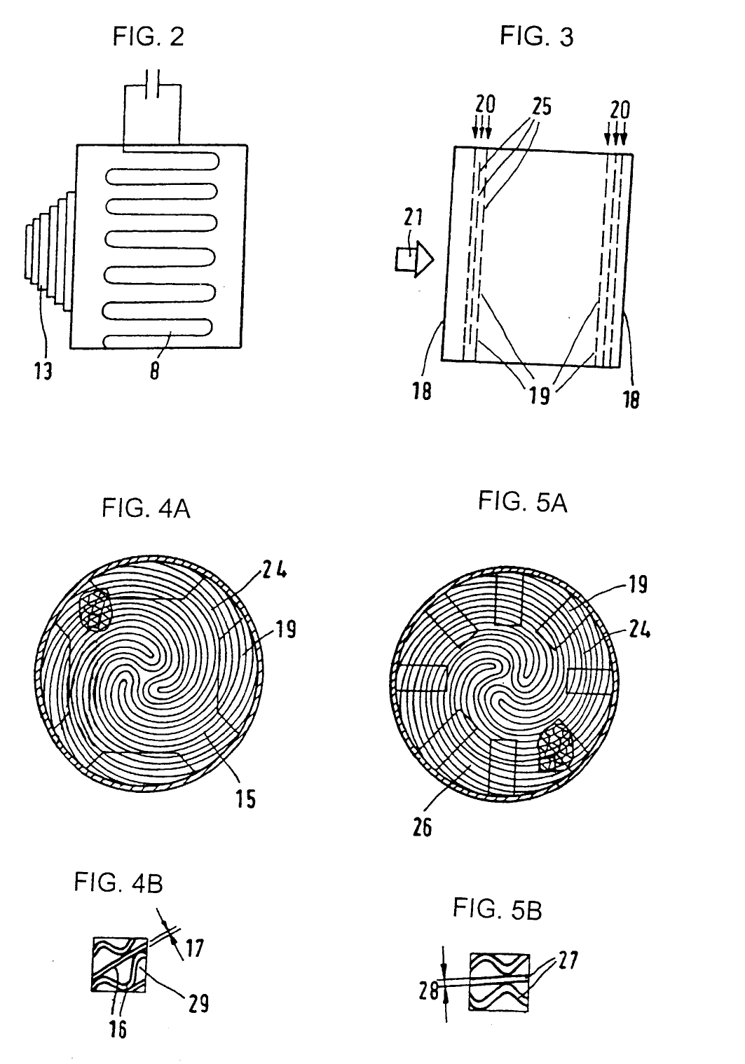

FIG. 2 shows a side view of an embodiment of a honeycomb body 6 or 7. This honeycomb body shown in FIG. 2 is provided with extensions 13 in order to reduce convection in the adjacent air gaps 14 close to the honeycomb bodies 6 or 7. The illustrated embodiment of the honeycomb body is constructed with partially structured foil layers 15 (shown in FIG. 4A) which have been produced by winding and/or stacking. In this case, individual foil layers 15 project beyond the end side of the honeycomb body 6 or 7. Accordingly, the actual extension 13 is formed directly from the foil layers 15, by foil layers which have larger dimensions and/or are offset with respect to other layers.

Furthermore, the honeycomb body shown in FIG. 2 has an electrical heater 8 which is disposed on the honeycomb body 6 or 7. The figure illustrates a heating wire 8 which is wound around the honeycomb body 6, 7 as an example. However, the foil layers of the honeycomb body 6, 7 may also be used directly as electrical heating resistors. It is also possible for a heating wire to be disposed in the interior of the honeycomb body 6, 7. An electrically heatable honeycomb body 6 or 7 can used both to boost cold-starting performance in the short term after a prolonged operating break and to maintain a desired temperature in the exhaust-gas cleaning installation during relatively long operating breaks.

FIG. 3 shows a further embodiment of a honeycomb body 6 or 7 with thermally decoupled end surfaces 18. The thermally decoupled end surfaces 18 are ensured by slots 19, which are preferably disposed in different planes 20 and approximately perpendicular to the direction of flow 21. FIG. 3 shows that the slots 19 are disposed with a mutual offset 25. This results in a type of labyrinth which reduces the thermal conduction from the interior of the honeycomb body 6 or 7 to the outside during the cooling operation. The slots 19 have an encircling construction and extend radially inward. The dimensions of the slots 19 are selected in such a way that the stability and strength of the honeycomb body 6, 7 are nevertheless ensured.

FIG. 4A shows an end-elevational view of a honeycomb body 6, 7 with foil layers 15 which have been produced by winding and/or stacking. The sheet-metal layers 15 are at least partially structured and are constructed with foils 16 which have a predeterminable foil thickness 17, as seen in FIG. 4B, which is an enlarged view of a broken-away portion of FIG. 4A. The honeycomb body 6, 7 of this embodiment has a catalytically active surface 29.

Furthermore, FIG. 4A illustrates an embodiment of the slots 19. The slots 19 are spaced apart from one another by notches 24. The notches 24 contribute to the stability of the honeycomb body 6, 7.

FIG. 5A shows a section through a catalytic converter 5. The catalytic converter which is illustrated therein has at least partially structured sheet-metal layers 26 which are produced by winding and/or stacking and are constructed with metal sheets 27 having a predeterminable metal-sheet thickness 28, as seen in FIG. 5B, which is an enlarged view of a broken-away portion of FIG. 5A. This catalytic converter 5 has thermally decoupled end surfaces 18 which are formed by a multiplicity of slots 19 and notches 24.

We claim:

1. An exhaust gas system for an internal combustion engine, comprising:
an exhaust-gas cleaning installation having an entry region, an exit region and a central region;
a catalytic converter in said central region, a first honeycomb body in said entry region and a second honeycomb body in said exit region, for conducting an exhaust gas flow through said first and second honeycomb bodies and said catalytic converter;
at least one of said honeycomb bodies being at least one of constructed, secured and disposed to form thermal insulation (8, 9, 10, 11, 12, 13, 16, 18, 19, 22, 23) reducing at least one of thermal conduction and thermal radiation from said catalytic converter into a remainder of the exhaust system; and
said first honeycomb body having a first entry end surface and a first exit end surface, said first entry end surface being smaller than said first exit end surface, and said first honeycomb body being oriented with said first exit end surface directed toward said catalytic converter.

2. The exhaust gas system according to claim 1, wherein at least one of said honeycomb bodies is made from thermally insulating material.

3. The exhaust gas system according to claim 2, wherein at least one of said honeycomb bodies is made from ceramic material.

4. The exhaust gas system according to claim 1, wherein at least one of said honeycomb bodies is electrically heatable.

5. The exhaust gas system according to claim 1, wherein said second honeycomb body has a second entry end surface and a second exit end surface, said second entry end surface is larger than said second exit end surface and said second entry end surface is oriented toward said catalytic converter.

6. The exhaust gas system according to claim 1, wherein said honeycomb bodies are spaced apart from said catalytic converter, defining air gaps each disposed between said catalytic converter and a respective one of said honeycomb bodies, and at least one of said honeycomb bodies has axial extensions passing into one of said air gaps and reducing convection in said one of said air gaps.

7. The exhaust gas system according to claim 1, wherein at least one of said honeycomb bodies has at least partially structured foil layers being at least one of wound and stacked, and said foil layers have foils with a foil thickness of 0.015 to 0.035 mm.

8. The exhaust gas system according to claim 1, wherein at least one of said honeycomb bodies has at least one thermally decoupled end surface.

9. The exhaust gas system according to claim 8, wherein at least one of said honeycomb bodies has an interior with at least one slot disposed in vicinity of said at least one thermally decoupled end surface.

10. The exhaust gas system according to claim 9, wherein said at least one slot has an encircling structure and extends radially inwardly.

11. The exhaust gas system according to claim 9, wherein said at least one slot has at least one notch.

12. The exhaust gas system according to claim 9, wherein said at least one slot is a plurality of slots disposed perpendicular to a preferred exhaust gas flow direction.

13. The exhaust gas system according to claim 12, wherein said slots are disposed in different planes.

14. The exhaust gas system according to claim 12, wherein each of said slots has at least one notch, and said notches are mutually offset.

15. The exhaust gas system according to claim 1, wherein at least one of said honeycomb bodies is disposed at an axial distance of 1 to 2 mm from said catalytic converter.

16. The exhaust gas system according to claim 1, which further comprises insulating securing elements spacing at least one of said honeycomb bodies apart from said catalytic converter.

17. The exhaust gas system according to claim 1, wherein said catalytic converter has thermally decoupled end surfaces.

18. The exhaust gas system according to claim 1, wherein said catalytic converter has at least partially structured sheet-metal layers being at least one of wound and stacked, said sheet-metal layers having metal sheets with a thickness of 0.08 mm to 0.11 mm.

19. The exhaust gas system according to claim 1, wherein said exhaust-gas cleaning installation has convection barriers disposed between said exhaust-gas cleaning installation and said catalytic converter, said first honeycomb body and said second honeycomb body.

20. The exhaust gas system according to claim 19, wherein said exhaust-gas cleaning installation has a thermally insulated radially outer side.

21. The exhaust gas system according to claim 20, wherein at least one of said honeycomb bodies is thermally insulatedly secured to said exhaust-gas cleaning installation.

22. The exhaust gas system according to claim 1, wherein at least one of said honeycomb bodies has a catalytically active surface, along which exhaust gas flows.

23. The exhaust gas system according to claim 1, wherein said first honeycomb body has a catalytically active surface, and said first honeycomb body is constructed for very rapidly achieving a high conversion rate with regard to hydrocarbons and carbon monoxide during a cold-starting phase.

24. The exhaust gas system according to claim 23, wherein said high conversion rate is a rate of at least 80% after 10 to 20 seconds.

25. The exhaust gas system according to claim 23, wherein said first honeycomb body has a volume of 0.2 to 1.0 liter.

26. The exhaust gas system according to claim 23, wherein said first honeycomb body has a volume of 0.6 liter.

27. The exhaust gas system according to claim 19, which further comprises a primary catalytic converter connected upstream of said exhaust-gas cleaning installation in an exhaust gas flow direction.

28. The exhaust gas system according to claim 27, wherein said primary catalytic converter has a volume of 0.2 to 1 liter.

29. The exhaust gas system according to claim 27, wherein said primary catalytic converter has a volume of approximately 0.6 liter.

30. The exhaust gas system according to claim 27, wherein said primary catalytic converter has an electrical heater.
